(19) United States
(12) Patent Application Publication
(10) Pub. No.: US 2016/0147436 A1
(43) Pub. Date: May 26, 2016

(54) ELECTRONIC APPARATUS AND METHOD

(71) Applicant: Kabushiki Kaisha Toshiba, Tokyo (JP)

(72) Inventor: Hideki Tsutsui, Kawasaki Kanagawa (JP)

(21) Appl. No.: 15/009,619

(22) Filed: Jan. 28, 2016

Related U.S. Application Data
(63) Continuation of application No. PCT/JP2014/056295, filed on Mar. 11, 2014.

(51) Int. Cl. G06F 3/0488

(52) U.S. Cl. CPC G06F 3/04883

(57) ABSTRACT

According to one embodiment, an electronic apparatus includes a hardware processor. The hardware processor sets a first attribute of strokes to be made on a screen, wherein the first attribute determines a degree of change in thicknesses or colors of the strokes according to a change of writing pressure of the strokes; receives a first stroke made on the screen; display the first stroke in accordance with the first attribute on the screen; determines a handwriting candidate conforming the first stroke, wherein the handwriting candidate includes a second attribute different from the first attribute; changes a form of the handwriting candidate in accordance with a difference between the first attribute and the second attribute; and displays the handwriting candidate according to the first attribute on the screen.

### CROSS-REFERENCE TO RELATED APPLICATIONS

This application is a Continuation Application of PCT Application No. PCT/JP2014/056295, filed Mar. 11, 2014, the entire contents of which are incorporated herein by reference.

### FIELD

Embodiments described herein relate generally to an electronic apparatus and a method.

### BACKGROUND

Recently, an electronic apparatus equipped with a touchscreen display has become widespread for facilitating an input operation by a user. The input operation by the touchscreen display is used not only for providing an operation instruction to the electronic apparatus but also for inputting a document by handwriting.

A history is often used to assist input in order to facilitate inputting a document by handwriting. In many cases, however, input is executed in a completely different state from the state where the user actually handwritten and the user feels a sense of incongruity.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus of an embodiment.

FIG. 2 is an exemplary illustration showing a collaborative operation by the electronic apparatus of the embodiment and external devices.

FIG. 3 is an exemplary illustration showing an example of a handwritten document handwritten on a touchscreen display of the electronic apparatus of the embodiment.

FIG. 4 is an exemplary illustration showing time-series data corresponding to the handwritten document of FIG. 3 and generated by the electronic apparatus of the embodiment.

FIG. 5 is an exemplary block diagram showing a system configuration of the electronic apparatus of the embodiment.

FIG. 6 is an exemplary block diagram showing a functional structure of a handwritten notebook application program running on the electronic apparatus of the embodiment.

FIG. 7 is an exemplary illustration showing an example of a page editing screen displayed by the handwritten notebook application program running on the electronic apparatus of the embodiment.

FIG. 8 is an exemplary illustration showing an example of a pen setting screen displayed by the handwritten notebook application program running on the electronic apparatus of the embodiment.

FIG. 9 is an exemplary first illustration showing an example of displaying recommended strokes by the handwritten notebook application program running on the electronic apparatus of the embodiment.

FIG. 10 is an exemplary second illustration showing an example of displaying recommended strokes by the handwritten notebook application program running on the electronic apparatus of the embodiment.

FIG. 11 is an exemplary illustration showing an example of completing handwritten strokes by the handwritten notebook application program running on the electronic apparatus of the embodiment.

FIG. 12 is an exemplary first illustration showing a fundamental principle of displaying (drawing) a locus of a stroke by the handwritten notebook application program running on the electronic apparatus of the embodiment.

FIG. 13 is an exemplary second illustration showing a fundamental principle of displaying (drawing) a locus of a stroke by the handwritten notebook application program running on the electronic apparatus of the embodiment.

FIG. 14 is an exemplary first illustration showing another example of displaying recommended strokes by the handwritten notebook application program running on the electronic apparatus of the embodiment.

FIG. 15 is an exemplary second illustration showing another example of displaying recommended strokes by the handwritten notebook application program running on the electronic apparatus of the embodiment.

FIG. 16 is an exemplary flowchart showing a procedure of stroke completion executed by the handwritten notebook application program running on the electronic apparatus of the embodiment.

### DETAILED DESCRIPTION

Various embodiments will be described hereinafter with reference to the accompanying drawings.

In general, according to one embodiment, an electronic apparatus includes a screen, a storage and a hardware processor. The screen is configured to detect a stroke made on the screen and display the stroke. The storage is configured to store a document. The hardware processor is configured to: display the document on the screen; set a first attribute of strokes to be made on the screen, wherein the first attribute determines a degree of change in thicknesses or colors of the strokes according to a change of writing pressure of the strokes; receive a first stroke made on the screen; display the first stroke in accordance with the first attribute on the screen; determine a handwriting candidate conforming the first stroke, wherein the handwriting candidate includes a second attribute different from the first attribute; change a form of the handwriting candidate in accordance with a difference between the first attribute and the second attribute; and display the handwriting candidate according to the first attribute on the screen.

FIG. 1 is an exemplary perspective view showing an appearance of an electronic apparatus of an embodiment. The electronic apparatus is, for example, a pen-based portable electronic apparatus that permits a pen (stylus) or a finger to input handwriting. The electronic apparatus can be implemented as a tablet computer, a notebook computer, a smartphone, a PDA, etc. In the description below, it is assumed that the electronic apparatus is implemented as a tablet computer 10. The tablet computer 10 is a portable electronic apparatus which is also called a tablet or a slate computer. As shown in FIG. 1, the tablet computer 10 comprises a body 11 and a touchscreen display 17. The body 11 has a thin box-shaped housing. The touchscreen display 17 is attached to the body 11 to overlap the top surface of the body 11.

A flat-panel display and a sensor are incorporated into the touchscreen display 17. The sensor is configured to detect the contact position of a pen or a finger on the screen of the flat-panel display. The flat-panel display may be, for example, a liquid crystal display (LCD) device. As the sensor, for example, a capacitive touch panel, an electromagnetic induction type digitizer and the like may be used. In the description below, it is assumed that two types of sensors, i.e., the digitizer and the touch panel are incorporated into the touchscreen display 17.

The digitizer is provided under the screen of the flat-panel display, for example. The touch panel is provided on the screen of the flat-panel display, for example. The touch screen display 17 can detect not only a touch operation on the screen using a finger, but also a touch operation on the screen using a pen 100. The pen 100 may be, for example, a digitizer pen (electromagnetic induction pen). The user can perform a handwriting input operation on the touchscreen display 17 by use of an external object (pen 100 or finger). During the handwriting input operation, a locus of the movement of the external object on the screen, i.e., a locus of a stroke input by handwriting is drawn in real time. The locus of each stroke is thereby displayed on the screen. The locus of the movement of the external object during the time when the external object is kept in contact with the screen corresponds to a stroke. A group of a large number of strokes, i.e., a group of a large number of loci corresponding to handwritten characters, figures or the like constitutes a handwritten document.

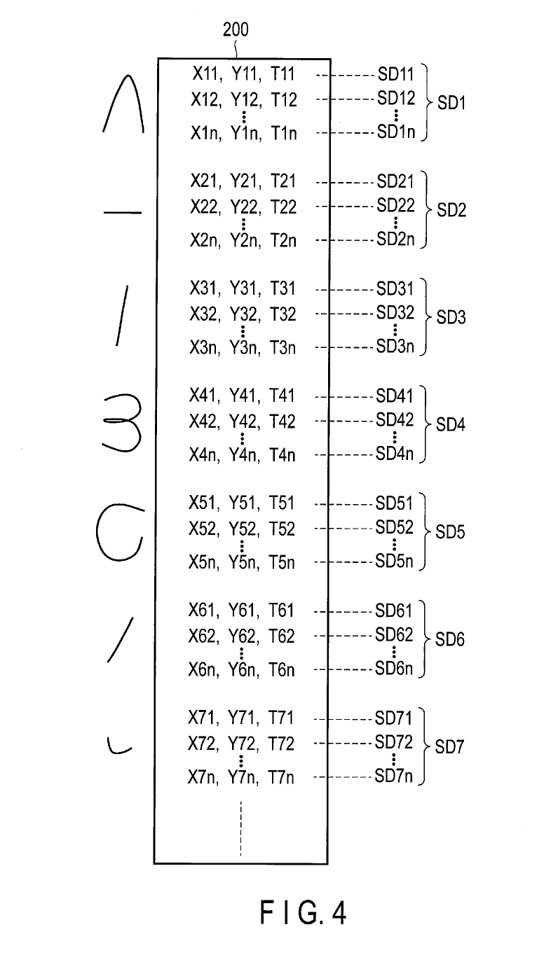

In the present embodiment, the handwritten document is stored in a storage medium not as image data but as time-series data indicative of a coordinate series of a locus of each stroke and indicative of the order relation of the strokes. The time-series data, which will be described in detail with reference to FIG. 4, indicates the order of making the strokes and includes stroke data items corresponding to the strokes, respectively. In other words, the time-series data means a group of time-series stroke data items corresponding to the respective strokes. Each stroke data item corresponds to a certain stroke and includes a coordinate data series (time-series coordinates) corresponding to respective points of a locus of the stroke. The order of arrangement of the stroke data items corresponds to the order of making the strokes, i.e., the stroke order.

The tablet computer 10 can read arbitrary existing time-series data (handwritten document data) from the storage medium and display, on the screen, a handwritten document corresponding to the time-series data, i.e., loci corresponding to the strokes indicated by the time-series data, respectively. The tablet computer 10 further comprises an edit function. By the edit function, an arbitrary stroke, character or the like in a displayed handwritten document can be erased or moved in accordance with an editing operation by the user using an eraser tool, a range specification tool or other tools. The edit function further includes a function of undoing several handwriting operations.

The tablet computer 10 further has a stroke completion (stroke recommendation) function. The stroke completion function is a function to assist a handwriting input operation by the user such that the user can easily input a number of character strings by handwriting.

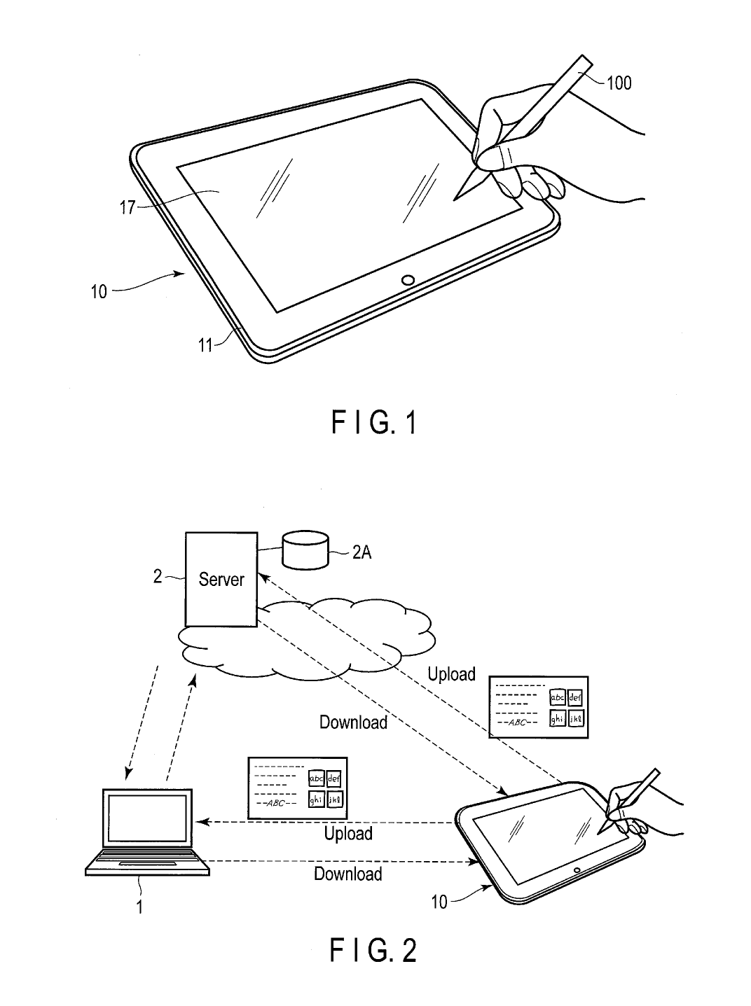

FIG. 2 shows an example of a collaborative operation by the tablet computer 10 and external devices. The tablet computer 10 can operate in cooperation with a personal computer 1 and a cloud. That is, the tablet computer 10 comprises a wireless communication device such as a wireless LAN device and can perform wireless communication with the personal computer 1. The tablet computer 10 can also communicate with a server 2 on the Internet. The server 2 may be a server providing various cloud computing services such as an online storage service.

The personal computer 1 comprises a storage device such as a hard disk drive (HDD). The tablet computer 10 can transmit time-series data (handwritten document) to the personal computer 1 through the network and store the data on the HDD of the personal computer 1 (upload).

Therefore, the tablet computer 10 can process a great number of items of time-series data (handwritten documents) or large volume time-series data (handwritten document) even if the storage capacity of the tablet computer 10 is small.

The tablet computer 10 can also read one or more arbitrary handwritten documents stored on the HDD of the personal computer 1 (download). The tablet computer 10 can display a locus of each stroke indicated by the read handwritten documents on the screen of the touchscreen display 17 of the tablet computer 10. In this case, a list of thumbnails obtained by scaling down each page of the time-series data items may be displayed on the screen of the touchscreen display 17, or a certain page selected from the thumbnails may be displayed on the screen of the touchscreen display 17 in a normal size.

As described above, the tablet 10 may communicate with the server 2 on the cloud providing a storage service, etc., instead of the personal computer 1. The tablet computer 10 can transmit a handwritten document to the server 2 through the network and store the data in a storage device 2A of the server 2 (upload). The tablet computer 10 can also read an arbitrary handwritten document stored in the storage device 2A of the server 2 (download). The tablet computer 10 can display a locus of each stroke indicated by the read handwritten document on the screen of the touchscreen display 17 of the tablet computer 10.

As described above, in the present embodiment, a handwritten document may be stored in any one of the storage device of the tablet computer 10, the storage device of the personal computer 1 and the storage device of the server 2.

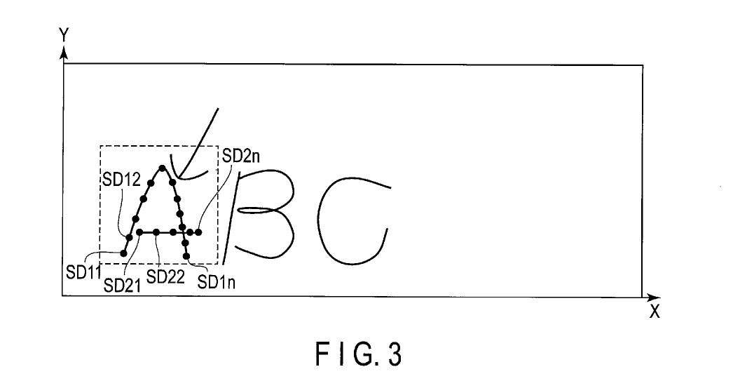

Next, a relationship between strokes (characters, marks, figures [diagrams], tables, etc.) handwritten by the user and a handwritten document is described with reference to FIG. 3 and FIG. 4. FIG. 3 shows an example of a handwritten character string handwritten on the touchscreen display 17 by use of the pen 100, etc.

In the handwritten document, a character or figure may often be handwritten on an already handwritten character or figure. In FIG. 3, it is assumed that a character string “ABC” is handwritten in the order “A”, “B” and “C”, and thereafter an arrow is handwritten close to the handwritten character “A”.

The handwritten character “A” is expressed by two strokes (a locus in the form of “̂” and a locus in the form of “−”), i.e., two loci handwritten by using the pen 100, etc. The first handwritten locus of the pen 100 in the form of “̂” is sampled in real time, for example, at regular intervals, and time-series coordinates SD11, SD12, . . . , SD1n corresponding to the stroke in the form of “̂” can be thereby achieved. In the same way, the second handwritten locus of the pen 100 in the form of “−” is sampled in real time at regular intervals, and time-series coordinates SD21, SD21, . . . , SD2n corresponding to the stroke in the form of “−” can be thereby achieved.

The handwritten character “B” is expressed by two strokes, i.e., two loci handwritten by using the pen 100, etc. The handwritten character “C” is expressed by a stroke, i.e., a locus handwritten by using the pen 100, etc. The handwritten arrow is expressed by two strokes, i.e., two loci handwritten by using the pen 100, etc.

FIG. 4 shows time-series data 200 corresponding to the handwritten character string of FIG. 3. The time-series data 200 includes stroke data items SD1, SD2, . . . , SD7. In the time-series data 200, these stroke data items SD1, SD2 . . . , SD7 are arranged on a time-series basis in the stroke order, i.e., in the order of making the strokes.

In the time-series data 200, the first and second stroke data items SD1 and SD2 indicate the two strokes of the handwritten character “A”, respectively. The third and fourth stroke data items SD3 and SD4 indicate the two strokes constituting the handwritten character “B”, respectively. The fifth stroke data item SD5 indicates the stroke constituting the handwritten character “C”. The sixth and seventh stroke data items SD6 and SD7 indicate the two strokes constituting the handwritten arrow, respectively.

Each stroke data item includes a coordinate data series (time-series coordinates) corresponding to a stroke, i.e., coordinates corresponding to points on a locus of the stroke, respectively. In each stroke data item, coordinates are arranged on a time-series basis in the order of making the stroke. For instance, regarding the handwritten character “A”, the stroke data item SD1 includes a coordinate data series (time-series coordinates) corresponding to points on the locus of the stroke “A” of the handwritten character “A”, respectively, i.e., n coordinate data items SD11, SD12, . . . , SD1n. The stroke data item SD2 includes a coordinate data series corresponding to points on the locus of the stroke “−” of the handwritten character “A”, respectively, i.e., n coordinate data items SD21, SD22, . . . SD2n. The number of coordinate data items may be different for each stroke data item. That is, since a locus of the pen 100 is sampled in real time at regular intervals, the number of coordinate data items increases as a stroke becomes longer or a speed of handwriting the stroke increases.

Each coordinate data item indicates an x-coordinate and a y-coordinate corresponding to a certain point on a corresponding locus. For instance, the coordinate data item SD11 indicates the x-coordinate (X11) and the y-coordinate (Y11) of the start point of the stroke “̂”. The coordinate data item SD1n indicates the x-coordinate (X1n) and the y-coordinate (Y1n) of the end point of the stroke “̂”.

Each coordinate data item may further include timestamp data T corresponding to a time at which a point corresponding to the coordinates was handwritten. The point-handwritten time may be an absolute time (for example, year, month, day, hour, second) or a relative time with respect to a certain time. For instance, an absolute time (for example, year, month, day, hour, second) when writing of a stroke has been started may be added to each stroke data item as timestamp data, and a relative time indicative of a difference from the absolute time may be further added to each coordinate data item in the stroke data item as timestamp data T.

By using time-series data in which timestamp data T is added to each coordinate data item as describe above, a temporal relationship between strokes can be expressed with higher accuracy.

Data (Z) indicative of writing pressure may also be added to each coordinate data item.

The time-series data 200 having the structure shown in FIG. 4 can indicate not only each stroke but also a temporal relationship between strokes. Therefore, even if the tip of the handwritten arrow overlaps or is close to the handwritten character “A” as shown in FIG. 3, the handwritten character “A” and the tip of the arrow can be processed as different characters or figures by using the time-series data 200. The timestamp data T may be used as optional data and stroke data items without time stamp data T may be used as the above-described time-series data.

In addition, as described above, a handwritten document is stored not as an image or a result of character recognition, but as a group of time-series stroke data items in the present embodiment. Thus, handwritten characters can be processed independently of language. Therefore, the structure of the time-series data 200 of the present embodiment can be commonly used in various countries having different languages around the world.

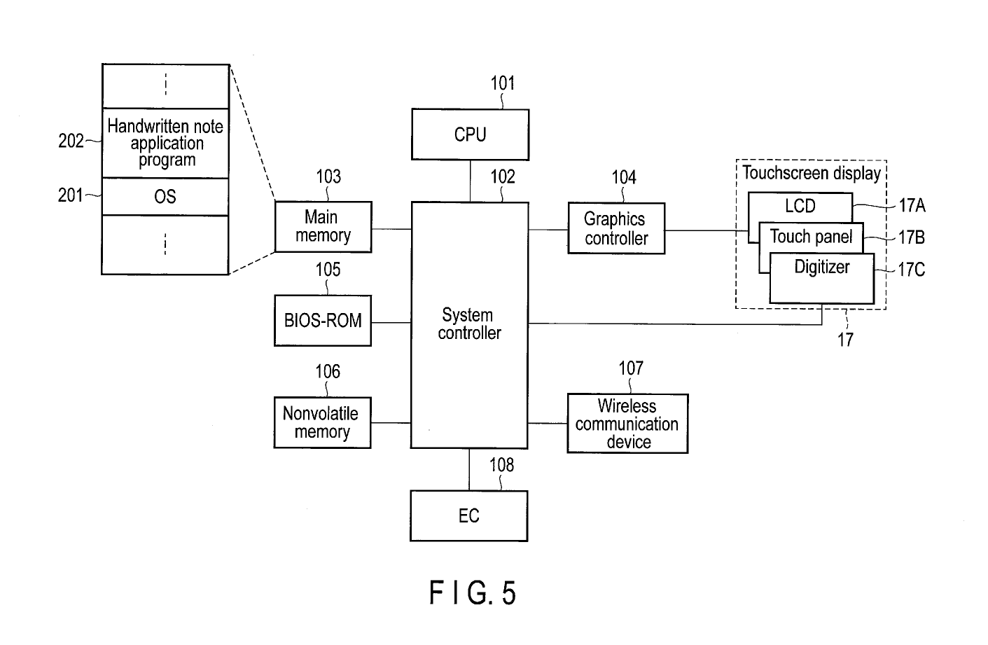

FIG. 5 is an exemplary diagram showing a system configuration of the tablet computer 10.

As shown in FIG. 5, the tablet computer 10 comprises a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor (a hardware processor) which controls operations of various modules in the tablet computer 10. The CPU 101 executes various computer programs loaded from the nonvolatile memory 106 serving as a storage device into the main memory 103. The programs include an operating system (OS) 201 and various application programs. The application programs include a handwritten note application program 202. The handwritten note application program 202 has a function of creating and displaying the handwritten document described above, a function of editing the handwritten document, a stroke completion function, etc.

The CPU 101 also executes a basic input/output system (BIOS) stored in the BIOS-ROM 105. The BIOS is a program for hardware control.

The system controller 102 is a device which connects between a local bus of the CPU 101 and various components. The system controller 102 is equipped with a memory controller which executes access control of the main memory 103. The system controller 102 also has a function of communicating with the graphics controller 104 via a serial bus conforming to the PCI Express standard.

The graphics controller 104 is a display controller which controls an LCD 17A used as a display monitor of the tablet computer 10. A display signal generated by the graphics controller 104 is transmitted to the LCD 17A. The LCD 17A displays a screen image based on the display signal. A touch panel 17B and a digitizer 17C are provided on the LCD 17A. The touch panel 17B is a capacitive pointing device to execute input on the screen of the LCD 17A. The contact position, the movement of the contact position, etc., of the finger on the screen are detected by the touch panel 17B. The digitizer 17C is an electromagnetic induction type pointing device to execute input on the screen of the LCD 17A. The contact position, the movement of the contact position, etc., of the pen 100 on the screen are detected by the digitizer 17C.

The wireless communication device 107 is a device configured to execute wireless communication such as wireless LAN or 3G mobile communication. The EC 108 is a shingle-chip microcomputer including an embedded controller for power management. The EC 108 has a function of powering on or off the tablet computer 10 in accordance with a power button operation by the user.

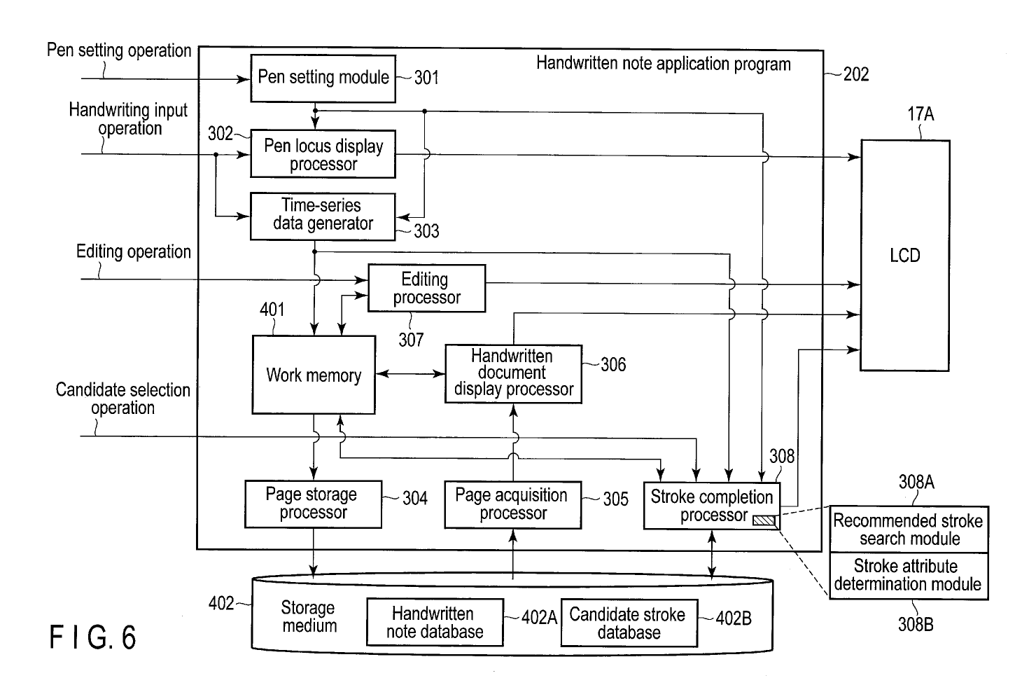

Next, a functional structure of the handwritten note application program 202 is described with reference to FIG. 6.

The handwritten note application program 202 comprises a pen setting module 301, a pen locus display processor 302, a time-series data generator 303, a page storage processor 304, a page acquisition processor 305, a handwritten document display processor 306, an editing processor 307, a stroke completion processor 308, etc.

The handwritten note application program 202 creates, displays and edits a handwritten document by using stroke data input by use of the touchscreen display 17. The touchscreen display 17 is configured to detect occurrence of events such as a touch, move (slide) and release. A touch is an event indicating that an external object has touched the screen. A move (slide) is an event indicating that a contact position has been moved while the external object is kept in contact with the screen. A release is an event indicating that the external object has been lifted from the screen.

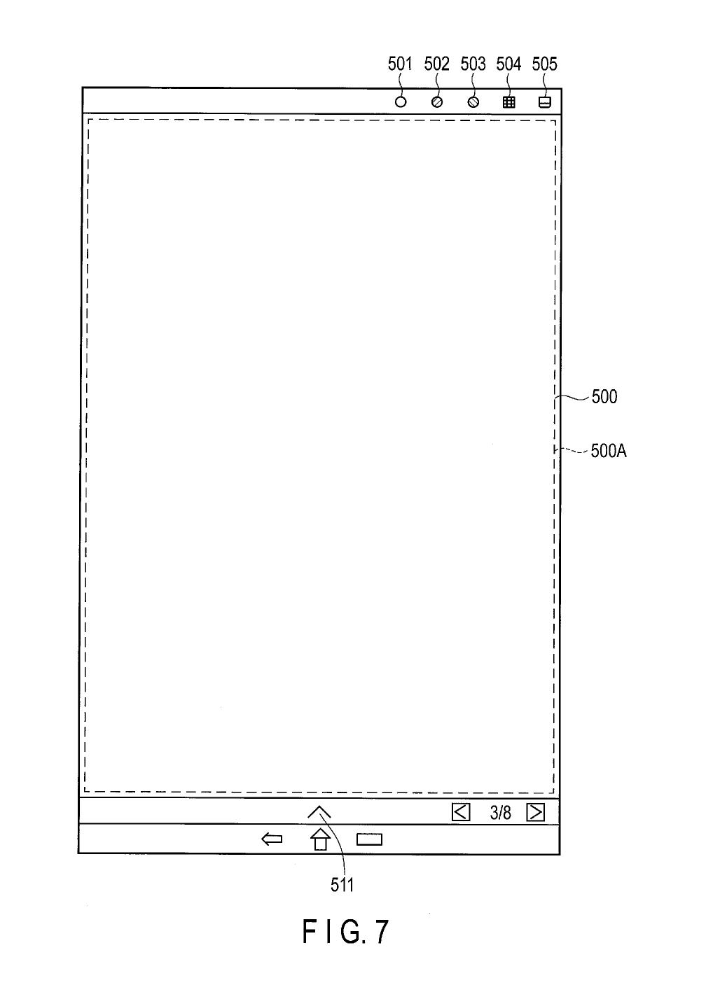

The handwritten note application program 202 displays a page editing screen 500 for creating, displaying and editing a handwritten document on the touchscreen display 17. FIG. 7 is an exemplary illustration showing an example of the page editing screen 500 displayed by the handwritten notebook application program 202.

On the page editing screen 500 shown in FIG. 7, a rectangular area 500A surrounded by dashed lines is a handwriting input area in which handwriting input is possible. In the handwriting input area 500A, an input event from the digitizer 17C is used for displaying (drawing) a stroke but is not used as an event indicating a gesture such as a tap. In areas other than the handwriting input area 500A, an input event from the digitizer 17C can also be used as an event indicating a gesture such as a tap.

On the page editing screen 500, an input event from the touch panel 17B is used as an event indicating a gesture such as a tap but is not used for displaying (drawing) a locus of a stroke.

The page editing screen 500 further displays a quick-select menu including three types of pens 501 to 503, a range selection pen 504 and an erasing pen 505. The user can switch pen types to be used by tapping any one of the pens (buttons) in the quick-select menu with the pen 100 or the finger. For example, it is assumed that a black pen 501, a red pen 502 and a highlighter 503 are registered by the user. In this case, for example, when a handwriting input operation using the pen 100 is performed on the page editing screen 500 when the black pen 501 has been selected by a tap gesture by the user using the pen 100 or the finger, the handwritten note application program 202 displays the locus of a black stroke on the page editing screen 500 in accordance with the movement of the pen 100. In each of the three types of pens 501 to 503 in the quick-select menu, a frequently-used combination of color, width, etc., of the pen can be set.

The page editing screen 500 further displays a menu button 511. The menu button 511 is a button for displaying a menu. The user can display a set of software buttons as a menu on the page editing screen 500 by operating the menu button 511. The set of software buttons includes a button for calling up a pen setting screen 600 for setting a combination of color, width, etc., of each of the three types of pens 501 to 503 in the quick-select menu.

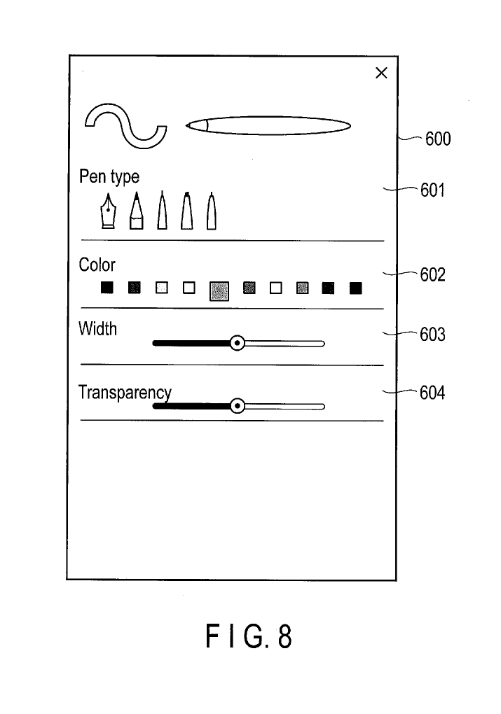

FIG. 8 is an exemplary illustration showing an example of the pen setting screen 600 displayed by the handwritten notebook application program 202.

The pen setting screen 600 comprises a field 601 for setting the pen type, a field 602 for setting the line color, a field 603 for setting the line width and a field 604 for setting the line transparency. The user can set a combination of color, width, etc., of each of the three types of pens 501 to 503 in the quick-select menu by the pen setting screen 600. The line transparency is transparency of background color. Setting the line transparency means setting the thickness (depth) of line.

The pen setting module 301 sets a display (drawing) form of a locus of a stroke such as coloring of the stroke in accordance with a user operation to the three types of pens (buttons) 501 to 503 in the quick-select menu on the page editing screen 500 and a user operation on the pen setting screen 600.

The pen locus display processor 302 and the time-series data generator 303 receive a touch or move (slide) event generated by the touchscreen display 17, and thereby detect a handwriting input operation. The touch event includes coordinates of a contact position. The move (slide) event also includes coordinates of a contact position as a destination. Therefore, the pen locus display processor 302 and the time-series data generator 303 can receive a series of coordinates corresponding to a locus of the movement of the contact position from the touchscreen display 17.

The pen locus display processor 302 functions as a display processor configured to display a stroke input by handwriting on the screen of the touchscreen display 17. The pen locus display processor 302 receives the coordinate series from the touchscreen display 17. The pen locus display processor 302 also receives data on writing pressure from the touchscreen display 17. Based on the coordinate series and the data on writing pressure received from the touchscreen display 17 and data on a combination of line color, line width, etc., set by the pen setting module 301, the pen locus display processor 302 displays loci of strokes input by a handwriting input operation using the pen 100, etc., on the screen of the LCD 17A in the touchscreen display 17.

The time-series data generator 303 receives the coordinate series output from the touchscreen display 17. The time-series data generator 303 generates stroke data items (time-series data items) corresponding to the strokes based on the coordinate series. These stroke data items, i.e., coordinates corresponding to each point on each stroke and timestamp data of each stroke may be temporally stored in a work memory 401. The data on writing pressure output from the touchscreen display 17 and the data on a combination of line color, line width, etc., set by the pen setting module 301 are also included in each stroke data item as attribute data.

The page storage processor 304 stores handwritten document data including the stroke data items corresponding to the strokes in a handwritten note database 402A in a storage medium 402. As described above, the storage medium 402 may be any one of the storage device of the tablet computer 10, the storage device of the personal computer 1 and the storage device of the server 2.

The page acquisition processor 305 reads arbitrary handwritten document data from the storage medium 402. The read handwritten document data is transmitted to the handwritten document display processor 306. The handwritten document display processor 306 analyzes the handwritten document data and displays, based on the analysis result, loci of strokes indicated by stroke data items in the handwritten document data as a handwritten page on the screen.

The editing processor 307 executes processing for editing the currently displayed handwritten document (handwritten page). That is, the editing processor 307 executes editing processing to delete or move at least one of the displayed strokes in accordance with an editing operation performed by the user on the touchscreen display 17. In addition, the editing processor 307 updates the handwritten document so as to reflect a result of the editing processing in the currently displayed handwritten document.

The user can erase an arbitrary stroke of the displayed strokes by using, for example, an eraser tool. The user can execute range specification for arbitrary part of the displayed handwritten page by using a range specification tool for surrounding arbitrary part of the screen by a circle or rectangle.

The stroke completion processor 308 is a processor configured to carry out the above-described stroke completion function. The stroke completion processor 308 comprises a recommended stroke search module 308A and a stroke attribute determination module 308B. In a stroke completion process, the stroke completion processor 308 acquires one or more stroke series (handwritten character strings) corresponding to a stroke input by handwriting from a group of previously input strokes (handwritten document data) by the recommended stroke search module 308A. The stroke completion processor 308 executes processing for displaying the acquired one or more stroke series on the screen as candidates for strokes that can be input (i.e., recommended strokes).

In other words, the stroke completion processor 308 predicts a stroke series (character string) that the user is going to handwrite based on the input stroke and the handwritten document data. Then, the stroke completion processor 308 shows the user several stroke series (handwritten character strings) obtained by the prediction as recommended strokes (candidate character strings).

For example, when a stroke (handwritten character) “a” is input by handwriting, a candidate such as a handwritten word “add” or “access” may be shown to the user. If the user selects the handwritten word “access”, the handwritten word “access” becomes an input handwritten character string. Therefore, the user can easily input a stroke series of the handwritten word “access”. The stroke completion processor 308 also determines an attribute of the handwritten word “access” by the stroke attribute determination module 308B. The function of the stroke attribute determination module 308B will be described later.

Handwritten character strings of any languages can be stored in handwritten document data. For example, various languages including English, Japanese and Chinese can be used. With respect to English handwritten character strings, a stroke series (handwritten character string) may be a stroke series corresponding to a string of block letters or a stroke series corresponding to a string of letters in script. A word handwritten in script is often constituted by a single stroke. Therefore, a stroke series acquired from the handwritten document data in the stroke completion process does not necessarily include strokes and may be constituted by a single stroke.

A stroke series corresponding to an input stroke may be, for example, strokes including a stroke similar to the input stroke or a single stroke partially similar to the input stroke. For example, a stroke series in which the first stroke (or the beginning of a stroke) is similar to the input stroke is acquired from the handwritten document data.

In order to easily acquire a stroke series corresponding to the input stroke from the handwritten document data, the stroke completion processor 308 may generate a candidate stroke database 402B based on a group of strokes (handwritten document data) stored in the handwritten note database 402A.

In the candidate stroke database 402B, for example, a stroke series (stroke data group) and a result of character recognition (character string) corresponding to the stroke data group may be stored in a unit of a meaningful character string such as a word.

In this case, the stroke completion processor 308 may first execute character recognition of a stroke input by the user. Then, the stroke completion processor 308 refers to the candidate stroke database 402B and finds a character string whose beginning matches a result of character recognition (character string) of the input stroke. The stroke completion processor 308 acquires a stroke series (stroke data group) corresponding to the found character string from the candidate stroke database 402B as a stroke series corresponding to the input stroke.

Instead, in the candidate stroke database 402B, for example, a stroke series (stroke data group) and a feature amount of each stroke corresponding to the stroke data group may be stored in a unit of a meaningful character string such as a word. As a feature amount of a stroke, an arbitrary feature that can express a feature of handwriting of the stroke can be used. For example, feature amount data indicating a shape, direction, slope, etc., of a stroke can be used as the feature amount. In this case, the stroke completion processor 308 may acquire a stroke series having a similar feature amount to the input stroke from the candidate stroke database 402B. In this case, the stroke completion processor 308 can search and show recommended strokes (candidate character string), for example, when part of a character is input.

In the candidate stroke database 402B, for example, a stroke series (stroke data group), a result of character recognition (character string) corresponding to the stroke data group and a feature amount of each stroke corresponding to the stroke data group may be stored in a unit of a meaningful character string such as a word.

The stroke completion processor 308 predicts a stroke series that the user is going to input based on the input stroke and the candidate stroke database 402B. In the prediction process, the stroke completion processor 308 acquires several stroke series (character strings, etc.) corresponding to the input stroke from the candidate stroke database 402B. Then, the stroke completion processor 308 executes processing for displaying the acquired stroke series on the screen as candidates for a handwritten character string predicted to be input (recommended strokes).

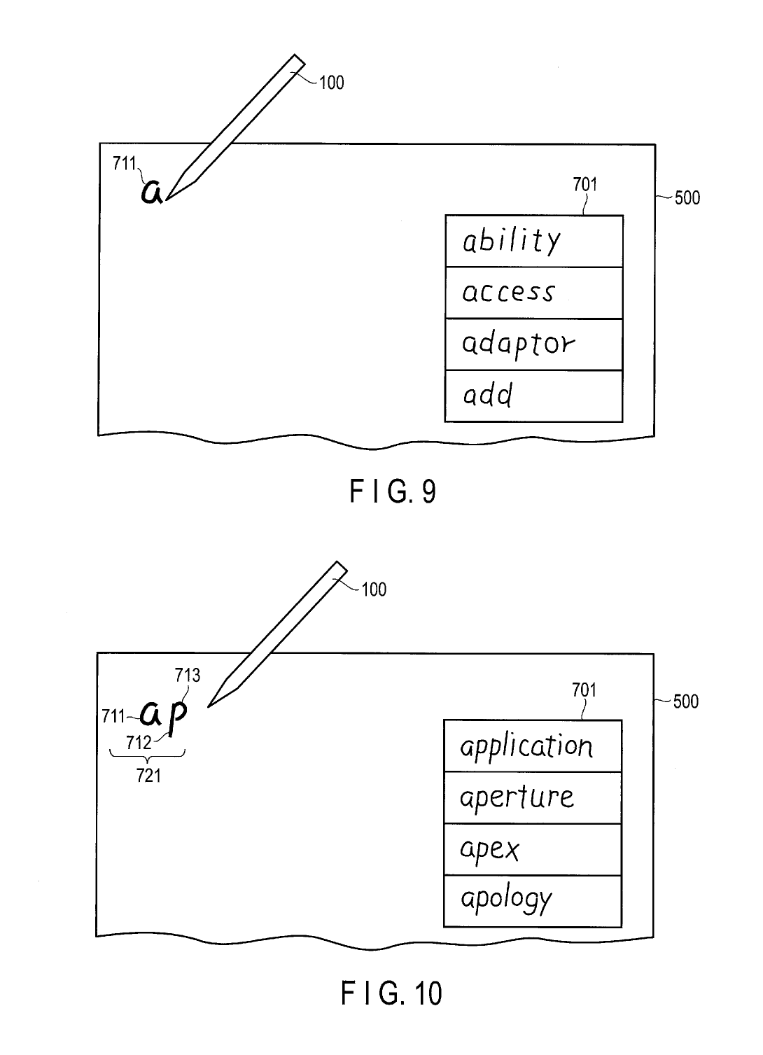

FIG. 9 is an exemplary first illustration showing an example of candidates (recommended strokes) corresponding to the input stroke.

In FIG. 9, it is assumed that a stroke 711 corresponding to a handwritten character “a” is input by a handwriting input operation on the page editing screen 500.

When the stroke 711 is input by handwriting, the stroke completion processor 308 acquires several stroke series (recommended strokes) corresponding to the input stroke 711 (in this case, the handwritten character “a”) from the candidate stroke database 4023. Then, the stroke completion processor 308 displays the stroke series in the recommended stroke list 701 on the page editing screen 500.

The input stroke 711 is processed as an undetermined stroke (or tentative stroke). The undetermined stroke means a stroke that is not yet reflected in a handwritten page. The undetermined stroke is a stroke to be subjected to stroke completion. Strokes predicted based on the undetermined stroke is shown to the user as recommended strokes. The stroke 711 may be displayed, for example, in a color different from the currently selected color such that the user can understand that the input stroke 711 is an undetermined stroke (tentative stroke).

In FIG. 9, it is assumed that four stroke series are shown as recommended strokes in the recommended stroke list 701. In FIG. 9, the four stroke series include handwritten character strings “ability”, “access”, “adaptor” and “add”.

In this manner, several stroke series (handwritten character strings) beginning with the handwritten character “a” are shown to the user. These stroke series are stroke series (handwritten character strings) previously input by the user by handwriting.

FIG. 10 is an exemplary second illustration showing an example of candidates (recommended strokes) corresponding to the input stroke.

In FIG. 10, it is assumed that strokes 712 and 713 corresponding to a handwritten character “p” are further input by a handwriting input operation on the page editing screen 500 after the stroke 711 corresponding to the handwritten character “a” is input. In this case, the recommended stroke list 701 is updated.

That is, the stroke completion processor 308 acquires several stroke series (recommended strokes) corresponding to the input strokes 711, 712 and 713 (handwritten character string “ap”) from the candidate stroke database 402B. Then, the stroke completion processor 308 displays these stroke series in the recommended stroke list 701 on the page editing screen 500.

In FIG. 10, it is assumed that four handwritten stroke series, i.e., handwritten character strings “application”, “aperture”, “apex” and “apology” are shown in the recommended stroke list 701 as recommended strokes.

In this manner, several handwritten character strings beginning with “ap” are shown to the user.

When the user selects certain recommended strokes in the recommended stroke list 701, the stroke completion processor 308 displays a stroke series corresponding to the selected recommended strokes on the page editing screen 500. In other words, the stroke completion processor 308 completes the input handwritten strokes with the stroke series corresponding to the selected recommended strokes. In this manner, the user can easily input a desired word only by inputting part of the desired word by handwriting.

With respect to a character constituted by several strokes such as a kanji character, the user can input the character only by inputting part of the several strokes by handwriting.

With respect to a letter string in script, the user can input the letter string in script only by inputting the beginning of a single stroke constituting the letter string.

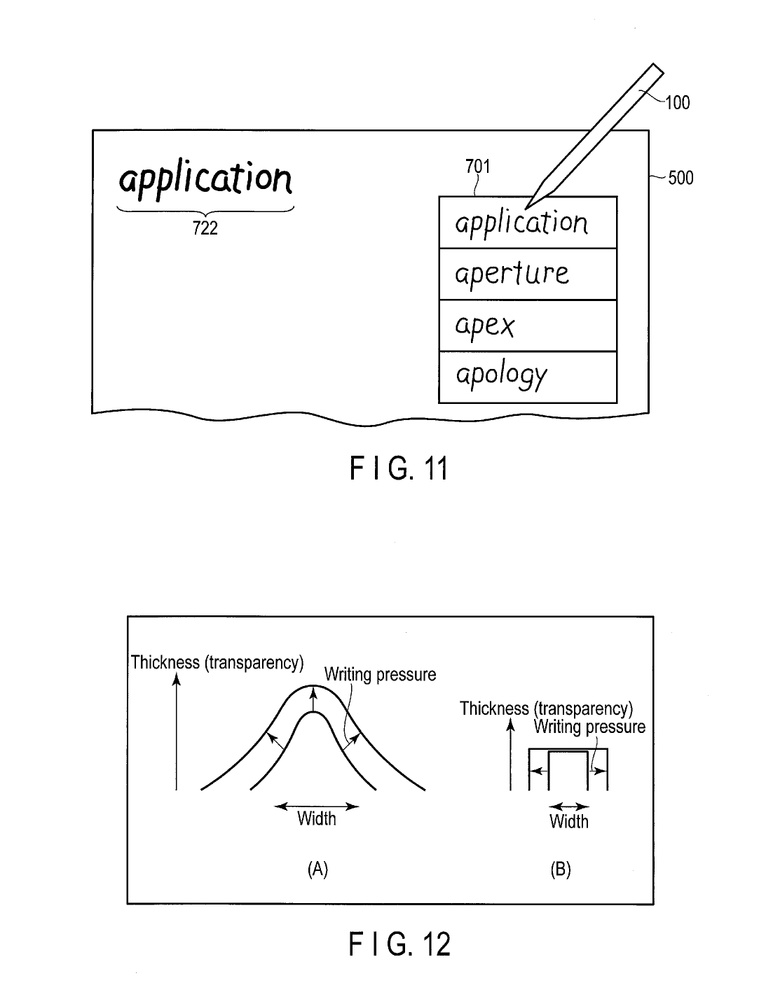

FIG. 11 is an exemplary illustration showing an example of completing input handwritten strokes.

In FIG. 11, it is assumed that the handwritten character string “application” in the recommended stroke list 701 is selected. When the handwritten character string “application” is tapped by the pen 100 or the finger, the stroke completion processor 308 executes processing for displaying the selected handwritten character string “application” on the page editing screen 50 in cooperation with the pen locus display processor 302 or the handwritten document display processor 306. In this case, the input strokes (strokes 711, 712 and 713 in FIG. 10) are completed by the handwritten character string “application”. In other words, the display processor displays the selected handwritten character string “application” on the page editing screen 500 instead of the input strokes (strokes 711, 712 and 713 in FIG. 10).

Then, the selected handwritten character string “application” becomes determined strokes and is reflected in the currently edited handwritten page. That is, the stroke data group of “application” acquired from the candidate stroke database 402B is added to the handwritten page. If the handwritten character string “application” is a stroke series written in script, a single stroke data item corresponding to the handwritten character string “application” is added to the handwritten page.

As described above, in the stroke completion process, several handwritten character strings corresponding to strokes (tentative strokes) input by handwriting are shown to the user as recommended strokes. Then, the selected recommended strokes (handwritten character string) are displayed on the page editing screen 500 instead of the tentative strokes.

Since the recommended strokes are stroke series (handwritten character strings) previously input by handwriting, however, the color, width, etc., of each recommended stroke (handwritten character string) may be different from those of the character string that the user is going to write. Accordingly, if the selected recommended strokes are simply displayed on the page editing screen 500, there is a possibility that recommended strokes (handwritten character string) having a color and width that are unnatural to the user are displayed.

Therefore, in the present embodiment, the stroke completion processor 308 determines an attribute of selected recommended strokes (722 in FIG. 11) to be displayed on the page editing screen 500 instead of tentative strokes (721 in FIG. 11), based on both of an attribute (writing pressure and setting data of used pen [data on combination of line color, line width, etc.]) of the tentative strokes and an attribute of the selected recommended strokes. The function of the stroke attribute determination module 308B is hereinafter described.

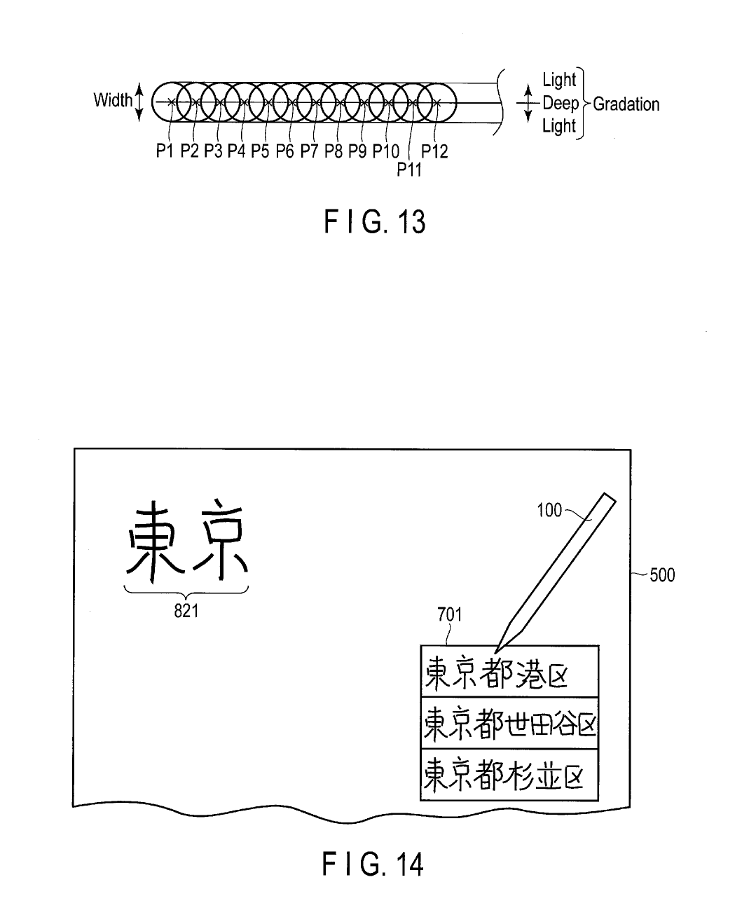

First, a fundamental principle of displaying (drawing) a locus of a stroke by the handwritten notebook application program 202 is described with reference to FIG. 12 and FIG. 13.

As described above, the user can switch pen types to be used by tapping the pens 501 to 503 in the quick-select menu displayed on the page editing screen 500, and set a combination of color, width, etc., of each of the pens 501 to 503 in the quick-select menu by the pen setting screen 600. In the description below, how a locus of a stroke is displayed (drawn) is described by assuming the following two cases: a case where a handwriting input operation is executed by the pen 100 when “brush” has been selected as the pen type; and a case where a handwriting input operation is executed by the pen 100 when “felt pen” has been selected as the pen type.

In FIG. 12, (A) shows an example of a display (drawing) pattern of a locus of a stroke in the case where “brush” is selected as the pen type in the field 601 of the pen setting screen 600, and (B) shows an example of a display (drawing) pattern of a locus of a stroke when “felt pen” is selected as the pen type.

When “brush” is selected as the pen type, as shown in FIG. 12(A), a parameter for the brush which smoothly changes the color from the center to the edge (from deep to light) is applied as a parameter regarding the coloring of strokes. In the parameter for the brush, the distance between the center and the edge varies according to the width setting in the field 603 of the pen setting screen 600 and a peak level of thickness increases and decreases according to the transparency setting in the field 604 of the pen setting screen 600. The parameter for the brush has characteristics of increasing both the width and the thickness as writing pressure increases. As a matter of course, the color set in the field 602 of the pen setting screen 600 is adopted as the color of a stroke.

When “felt pen” is selected as the pen type, as shown in FIG. 12(B), a parameter for the felt pen which does not change the color from the center to the edge is applied as a parameter regarding the coloring of strokes. That is, the degree of change in color is different for each pen type. In the parameter for the felt pen, the distance between the center and the edge varies according to the width setting in the field 603 of the pen setting screen 600 and a level of thickness entirely increases and decreases according to the transparency setting in the field 604 of the pen setting screen 600. The parameter for the felt pen has characteristics of increasing only the width as writing pressure increases. As a matter of course, the color set in the field 602 of the pen setting screen 600 is adopted as the color of a stroke.

The handwritten note application program 202 displays (draws) a locus of a stroke by displaying (drawing) a circle at each sampling point Pn in coordinate data in a locus of a handwritten stroke as shown in FIG. 13 based on parameters each having distinct characteristics. For example, in the case of the brush, the color is smoothly changed from the center to the edge (from deep to light), a visual effect of gradation can be achieved. In the example of FIG. 13, it is assumed that a stroke is input by handwriting with constant writing pressure, but if the writing pressure is changed, the size and the thickness of each displayed (drawn) circle are adaptively changed.

In light of the fundamental principle, the above-described case of displaying selected recommended strokes on the page editing screen 500 instead of tentative strokes is described again.

For example, it is assumed that the color of the pen used to input the handwritten characters “ap” in FIG. 10, i.e., tentative strokes, by handwriting is red, and the color of the pen used to input the handwritten character string “application” displayed in the recommended stroke list 701 of FIG. 10, i.e., recommended strokes, is black. If the handwritten character string “application” is selected by the user and the handwritten character string “application” is displayed (drawn) in black differently from the characters “ap” previously handwritten by the user and displayed in red, it is inevitable that the user feels a sense of incongruity. Therefore, if the user inputs “ap” in red by handwriting, the stroke attribute determination module 308B determines an attribute of the handwritten character string “application” such that the handwritten character string “application” is displayed (drawn) in red regardless of the fact that the color of the handwritten character string “application”, which is recommended strokes, is black in contrast to red.

In a similar way to color, the stroke attribute determination module 308B determines the attribute of the recommended strokes to be displayed on the page editing screen 500 instead of the tentative strokes with respect to the pen type, width and transparency based on the attribute of the currently used pen. In other words, the parameter regarding coloring of strokes shown in FIG. 12 is changed (as necessary). Therefore, when the tentative strokes are handwritten with the brush and the recommended strokes are handwritten with the felt pen, the recommended strokes (handwritten with the felt pen) can be displayed on the page editing screen 500 as if the recommended strokes are handwritten with the brush of the same width and transparency. The gradation shown in FIG. 13 can also be expressed in the same way as the tentative strokes.

As described above, the width and thickness of a locus of a stroke can be changed depending on writing pressure. Therefore, the stroke attribute determination module 308B determines the attribute of the recommended strokes to be displayed on the page editing screen 500 instead of the tentative strokes based on both the writing pressure of the tentative strokes and the writing pressure of the recommended strokes.

More specifically, the stroke attribute determination module 308B first calculates an average value of the writing pressure of the tentative strokes. To calculate the average value, all the tentative strokes constituting grounds for searching the recommended strokes or a threshold number of strokes from the last stroke of the tentative strokes may be used. All the tentative strokes may be used when the number of tentative strokes is less than the threshold number. The average value calculated at this time is expressed as Pm.

Next, the stroke attribute determination module 308B calculates an average value of the writing pressure of the recommended strokes (to be displayed on the page editing screen 500 instead of the tentative strokes). The average value calculated at this time is expressed as Ps. After calculating both the average values Pm and Ps, the stroke attribute determination module 308B calculates a difference Pd between these average values by formula Pd=Pm−Ps.

Then, the stroke attribute determination module 308B adds the difference Pd between the average values to writing pressure of each sampling point of the recommended strokes. If the average value Ps is greater than the average value Pm, the writing pressure is reduced.

In this manner, the recommended strokes can be displayed on the page editing screen 500 while reflecting changes in line width and thickness caused by changes in writing pressure at the time of handwriting input of the recommended strokes and matching the writing pressure of the recommended strokes to that of the tentative strokes.

As described above, the present embodiment can assist handwriting input without providing the user with a sense of incongruity by the function of the stroke attribute determination module 308B.

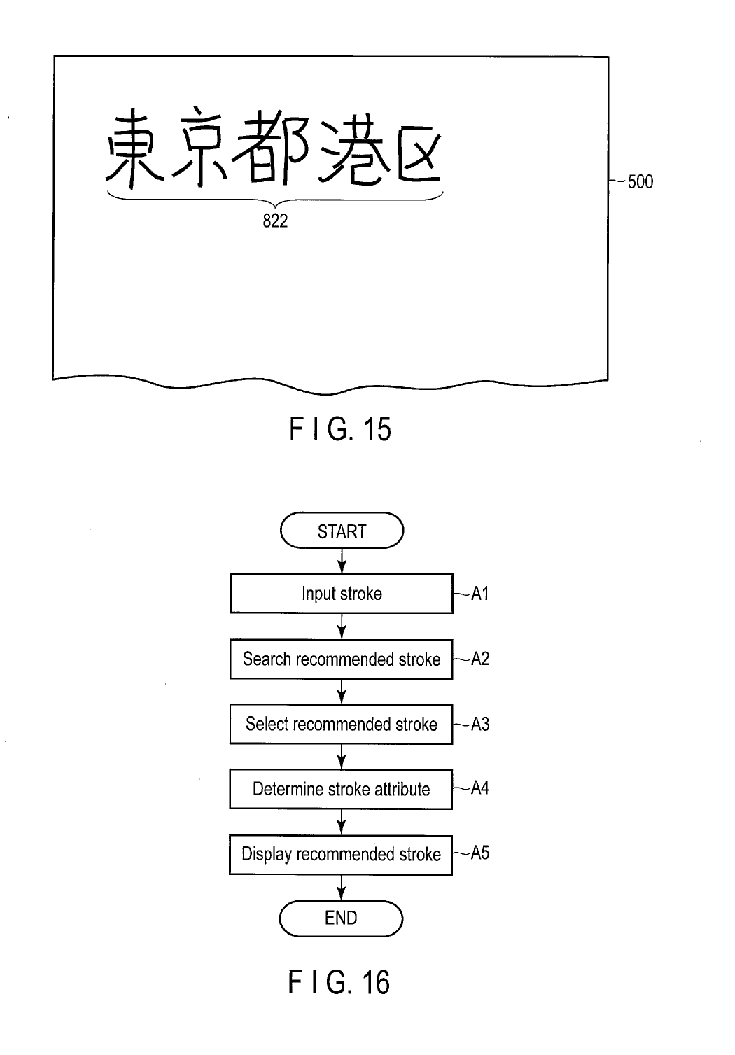

As described above, handwritten character strings of any languages can be stored in handwritten document data. Therefore, when Japanese characters (that means “Tokyo” in Japanese) are handwritten as shown in FIG. 14, a plurality of Japanese character strings (each of those means “Tokyo-to Minato-ku”, “Tokyo-to Setagaya-ku” and “Tokyo-to Suginami-ku” in Japanese) can be displayed in the recommended stroke list 701 based on the handwritten Japanese characters (tentative strokes 821). For example, when one of the plurality of Japanese character strings (that means “Tokyo-to Minato-ku” in Japanese) is selected as shown in FIG. 14, the selected character string (recommended strokes 822) can be displayed as shown in FIG. 15 without providing a sense of incongruity to the user who has handwritten the characters (that means “Tokyo” in Japanese), based on both the attribute of the handwritten characters (that means “Tokyo” in Japanese), which are tentative strokes, and the attribute of the selected character string (that means “Tokyo-to Minato-ku” in Japanese) displayed in the recommended stroke list 701.

FIG. 16 is an exemplary flowchart showing a procedure of stroke completion executed by the handwritten notebook application program 202.

The stroke completion processor 308 inputs a stroke input by handwriting through the time-series data generator 302 (block A1). The stroke completion processor 308 searches recommended strokes from the candidate stroke database 402B based on the input stroke by using the recommended stroke search module 308A (block A2). The searched recommended strokes are displayed on the page editing screen 500 as a recommended stroke list 701.

If any one of the recommended strokes in the recommended stroke list 701 is selected (block A3), the stroke completion processor 308 determines an attribute of the selected recommended stroke to be displayed on the page editing screen 500 instead of the stroke input by handwriting based on an attribute of the stroke input by handwriting and an attribute of the selected recommended stroke by using the stroke attribute determination module 308B.

Then, the stroke completion processor 308 displays the selected recommended stroke on the page editing screen 500 instead of the stroke input by handwriting based on the determined attribute.

As described above, the tablet computer 10 can assist handwriting input without providing the user with a sense of incongruity.

Since the entire operation procedure of the embodiment can be implemented by software, the same advantage as the embodiment can be easily achieved by installing the software on a general computer through a computer-readable storage medium.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a screen configured to detect a stroke made on the screen and display the stroke;
a storage configured to store a document; and
a hardware processor configured to:
display the document on the screen;
set a first attribute of strokes to be made on the screen, wherein the first attribute determines a degree of change in thicknesses or colors of the strokes according to a change of writing pressure of the strokes;
receive a first stroke made on the screen;
display the first stroke in accordance with the first attribute on the screen;
determine a handwriting candidate conforming the first stroke, wherein the handwriting candidate comprises a second attribute different from the first attribute;
change a form of the handwriting candidate in accordance with a difference between the first attribute and the second attribute; and
display the handwriting candidate according to the first attribute on the screen.

2. The electronic apparatus of claim 1, wherein the hardware processor is further configured to use the first attribute of a part of the first stroke to change the form of the handwriting candidate.

3. The electronic apparatus of claim 1, wherein:
the first attribute comprises colors of the strokes; and
the hardware processor is further configured to adopt a color of the first stroke to display the handwriting candidate.

4. The electronic apparatus of claim 1, wherein:
the first attribute comprises transmittance of background color regarding coloring of the strokes; and
the hardware processor is further configured to adopt transmittance of background color regarding coloring of the first stroke to display the handwriting candidate.

5. The electronic apparatus of claim 1, wherein:
the first attribute comprises a degree of change in width of the strokes according to the change of the writing pressure of the strokes; and
the hardware processor is further configured to use a degree of change in width of the strokes according to writing pressure of the first stroke to change the form of the handwriting candidate.

6. The electronic apparatus of claim 1, wherein the hardware processor comprises means for:
displaying the document on the screen;
setting a first attribute of strokes to be made on the screen, wherein the first attribute determines a degree of change in thicknesses or colors of the strokes according to a change of writing pressure of the strokes;
receiving a first stroke made on the screen;
displaying the first stroke in accordance with the first attribute on the screen;
determining a handwriting candidate conforming the first stroke, wherein the handwriting candidate comprises a second attribute different from the first attribute;
changing a form of the handwriting candidate in accordance with a difference between the first attribute and the second attribute; and
displaying the handwriting candidate according to the first attribute on the screen.

7. A method for an electronic apparatus, the method comprising:
detecting a stroke made on a screen, and displaying the stroke;
storing a document;
displaying the document on the screen;
setting a first attribute of strokes to be made on the screen, wherein the first attribute determines a degree of change in thicknesses or colors of the strokes according to a change of writing pressure of the strokes;
receiving a first stroke made on the screen;
displaying the first stroke in accordance with the first attribute on the screen;
determining a handwriting candidate conforming the first stroke, wherein the handwriting candidate comprises a second attribute different from the first attribute;
changing a form of the handwriting candidate in accordance with a difference between the first attribute and the second attribute; and
displaying the handwriting candidate according to the first attribute on the screen.

8. The method of claim 7, further comprising using the first attribute of a part of the first stroke to change the form of the handwriting candidate.

9. The method of claim 7, wherein:
the first attribute comprises colors of the strokes; and
the method further comprises adopting a color of the first stroke to display the handwriting candidate.

10. The method of claim 7, wherein:
the first attribute comprises transmittance of background color regarding coloring of the strokes; and
the method further comprises adopting transmittance of background color regarding coloring of the first stroke to display the handwriting candidate.

11. The method of claim 7, wherein:
the first attribute comprises a degree of change in width of the strokes according to the change of the writing pressure of the strokes; and
the method further comprises using a degree of change in width of the strokes according to writing pressure of the first stroke to change the form of the handwriting candidate.
